(19) United States
(12) Patent Application Publication
(10) Pub. No.: US 2025/0183556 A1
(43) Pub. Date: Jun. 5, 2025

(54) Antenna arrangement for a radar sensor

(71) Applicant: Balluff GmbH, Neuhausen (DE)

(72) Inventors: Patrick Schweizer, Filderstadt (DE); Matthias Hofherr, Karlsruhe (DE)

(73) Assignee: Balluff GmbH, Neuhausen (DE)

(21) Appl. No.: 18/964,958

(22) Filed: Dec. 2, 2024

(30) Foreign Application Priority Data
Dec. 5, 2023 (DE) 10 2023 133 942.7

(51) Int. Cl. H01Q 21/08; G01S 7/03; H01Q 9/04

(52) U.S. Cl. CPC H01Q 21/08; G01S 7/03; H01Q 9/045

(57) ABSTRACT

An antenna arrangement has a patch antenna with multiple notches and at least one pair of parasitic patches which are arranged in mirror symmetry at opposite ends of the patch antenna. A radar array, which is set up to transmit and receive radar waves, has multiple such antenna arrangements.

### FIELD

The present invention relates to an antenna arrangement. Furthermore, the present invention relates to a radar array having the antenna arrangement required for a radar sensor.

### PRIOR ART

Radar sensors for imaging processes require high operating bandwidths, since their resolution capacity is defined by the frequency bandwidth. A higher bandwidth therefore improves the separability of objects lying one behind the other. This is why we talk about ultra-wideband applications. Arrays which have multiple antennas are particularly suitable for such applications.

The implementation of such radar sensors with external wideband antennas that cannot be integrated into a printed circuit board (PCB) layout results in high effort for connection, unsuitable overall system sizes and high costs. The planar antennas, which exist according to scientific art, for board integration have the following disadvantages: spiral antennas have a high bandwidth, but are circularly polarised and not effective in radiation due to travelling wave characteristics. Bowtie antennas are broadband, but their main radiation direction is not orthogonal to the PCB, which disadvantages a suitable directivity for radar applications. LOG-periodic planar antennas are broadband, but their individual arms are already in an order of magnitude of an antenna array, such that multi-antenna patterns are unsuitable for them.

Different designs of patch antennas are described in Gatti at al., Single-Layer Line-Fed Broadband Microstrip Patch Antenna on Thin Substrates, Electronics 2021, 10, 1037. Such patch antennas have a limited bandwidth, which can only be insufficiently increased by dividing the pad with slots.

It is an object of the present invention to provide an antenna arrangement having a design that can be accommodated multiple times in a patternable array as a planar PCB design for an ultra-wideband application and does not have a complicated geometry. In this way, it should achieve a wider bandwidth than conventional patch antennas. A further object of the invention is to provide a radar array for imaging processes which has several such antenna arrangements.

### DISCLOSURE OF THE INVENTION

This object is solved in a first aspect of the invention by an antenna arrangement which has a patch antenna with multiple notches. These notches divide the patch antenna into a plurality of resonators. At least one pair of parasitic patches are arranged mirror-symmetrically at opposite ends of the patch antenna. This allows a large number of resonators of different lengths to be implemented, resulting in a broadband multi-resonator structure that can be adjusted using geometric parameters. The different lengths enable the antenna arrangement to resonate over a wide frequency range, in particular 57 to 64 GHz, and thus to work actively as an antenna. The resonators can be adapted to other frequency ranges by adjusting their length.

The notches of the patch antenna are preferably arranged axially symmetrically to a feed line of the patch antenna. This also results in symmetrical radiation for the H-field. If the patch antenna is not fed from below but from the side, symmetry is not possible due to the one-sided feed through a feed line orthogonal to the feed line. The radiation pattern of the present antenna arrangement corresponds closely to that of a typical rectangular patch antenna, such that the same rotationally symmetrical radiation can be achieved as with a pure patch.

Furthermore, it is preferable that the patch antenna has first notches that adjoin the feed line and second notches that are arranged parallel to the first notches. The feed point of the patch antenna can be optimised via the length of the first notches. It is set particularly preferably in this way such that an amount of electrical impedance at the feed point of the patch antenna is in the range of 40 Ω to 60 Ω and is particularly preferably 50 Ω. A patch antenna usually has a high impedance at its edge, while the impedance in the centre of the patch antenna is 0 Ω. The impedance of the patch antenna can be adapted to the impedance of the feed line, which is in particular a microstrip line with inset feed, by the length of the first notches. This means that no transformation network is required to adapt the high impedance of the patch antenna to the impedance of the feed line. The second notches separate the resonators from each other. The impedance adaption of the outer resonators can be adjusted via their length.

The parasitic patches can be used to increase the normally limited bandwidth of the patch antenna beyond the frequency limits that are set for a bandwidth adjustment merely by notches in the patch antenna. Preferably, the parasitic patches also each have at least one notch in order to divide them into multiple resonators, in particular into two resonators.

It is preferable that the notches of the parasitic patches are each arranged on sides that do not adjoin the patch antenna. In particular, they run parallel to the notches of the patch antenna. Furthermore, they run, in particular, parallel or orthogonal to a feed line of the patch antenna.

The parasitic patches are not electrically connected to the feed line. Instead, they are electrically insulated from the patch antenna by an air gap. A width of the air gap between the patch antenna and a parasitic patch is in particular less than 10% of a length of the side of the patch antenna facing the parasitic patch in each case.

The antenna arrangement is designed in such a way that it can be easily integrated into a PCB layout. For this purpose, a conductive structured layer is preferably provided, which is arranged on a dielectric substrate which is in particular single-layered. On the back of the substrate, there is another full-surface conductive layer that serves as a ground plane. This design makes it possible to transmit and receive directional and rear-shielded signals, while at the same time the antenna arrangement remains compact and cost-effective.

In a further aspect, the invention relates to a radar array which is set up for transmitting and receiving radar waves with an average wavelength λ. This has a plurality of antenna arrangements according to the first aspect of the invention. These antenna arrangements can be used as transmitting antennas and/or as receiving antennas. These are preferably set up to form a MIMO (Multiple Input Multiple Output) system and thus provide a plurality of virtual antenna pairs.

In a preferred embodiment of the radar array, antenna arrangements intended to serve as receiving antennas are arranged in a row. Antenna arrangements intended to serve as transmitting antennas can also be arranged in a row. The distance between the individual antenna arrangements is λ. Within the row, the antenna arrangements are arranged in such a way that all patch antennas form a row that is arranged between two rows of parasitic patches.

All notches of the parasitic patches are arranged in particular on the side facing away from their respective patch antenna.

In particular, this radar array can be implemented in such a way that all notches of the patch antennas are arranged on the same side of the row of patch antennas. In this case, all feed lines of the patch antennas are led out of the row on the side on which the notches are located.

Furthermore, the radar array can be implemented in particular in such a way that the patch antennas have notches on both sides of the row of patch antennas. Here too, it is provided that the feed lines are all directed to the same side of the row. However, an extension is also provided on each patch antenna, which is designed as an elongation of the feed line. In particular, this extension is so long that it ends at the edge of the row facing away from the feed lines together with the outer edges of the parasitic patches arranged there.

In another preferred embodiment of the radar array, the antenna arrangements set up as receiving antennas are arranged in two rows. The antenna arrangements set up as transmitting antennas can also be arranged in two rows. A distance between the two rows is λ. A distance between two antenna arrangements within a row is 2λ. This can increase the resolution of the radar sensor and compensate for the effect that the antenna arrangement has an increased expansion in width compared to a patch antenna without parasitic patches.

In each row, the patch antennas and the parasitic patches preferably lie on the longitudinal axis of the row.

Furthermore, it is preferred that all notches of the patch antennas are arranged on the same side of the radar array. This is the side of the row to which the feed lines continue. The feed lines of a row are continued towards their edge from the antenna arrangements, and the feed lines of the neighbouring row are continued between two antenna arrangements of the first row in the same direction as the feed lines of the first row. The parasitic patches each have at least one notch on two opposite sides in particular, wherein these notches run orthogonally to the longitudinal axis of the row. In this way, a mirror-symmetrical form of the parasitic patches can be implemented.

In all embodiments of the radar array, this enables a high resolution and depth of focus of radar images for an imaging radar sensor system.

### BRIEF DESCRIPTION OF THE DRAWINGS

Exemplary embodiments of the invention are represented in the drawings and are explained in more detail in the following description.

FIG. 1 shows a patch antenna according to the prior art.

FIG. 2 shows another patch antenna according to the prior art.

FIG. 3 shows an antenna arrangement according to an exemplary embodiment of the invention.

FIG. 4 shows a diagram comparing the input reflection coefficients of the patch antennas according to FIGS. 1 and 2 and the antenna arrangement according to FIG. 3.

FIG. 5 shows an array of multiple antenna arrangements for a radar sensor according to an exemplary embodiment of the invention.

FIG. 6 shows, in a diagram, a possible implementation of the MIMO approach of the radar array according to FIG. 5.

FIG. 7 shows an antenna arrangement according to another exemplary embodiment of the invention.

FIG. 8 shows an array of multiple antenna arrangements for a radar sensor according to a further exemplary embodiment of the invention.

FIG. 9 shows an antenna arrangement according to yet another exemplary embodiment of the invention.

FIG. 10 shows an array of multiple antenna arrangements for a radar sensor according to yet another exemplary embodiment of the invention.

FIG. 11 shows, in a diagram, the MIMO principle of the radar array according to FIGS. 8 and 10.

### EXEMPLARY EMBODIMENTS OF THE INVENTION

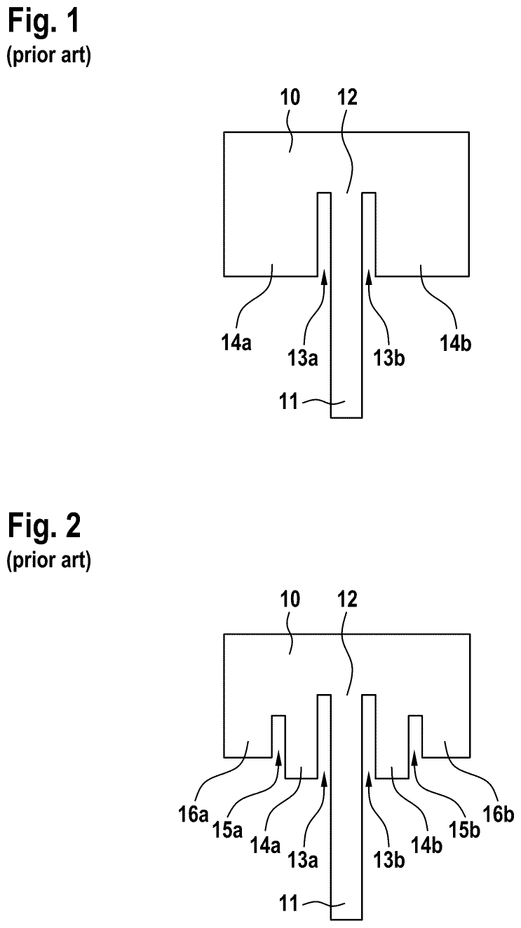

FIGS. 1 and 2 represent patch antennas fed via a microstrip, as are known from Gatti at al., Single-Layer Line-Fed Broadband Microstrip Patch Antenna on Thin Substrates, Electronics 2021, 10, 1037. The patch antenna 10 according to FIG. 1 has a feed line 11 which ends at a feed point 12 on an edge of the patch antenna 10. The feed point 12 has been set to an electrical impedance of 50 Ω by means of notches 13a, 13b on both sides of the feed line 11. Beyond the two notches 13a, 13b, the patch antenna 10 has two resonators 14a, 14b.

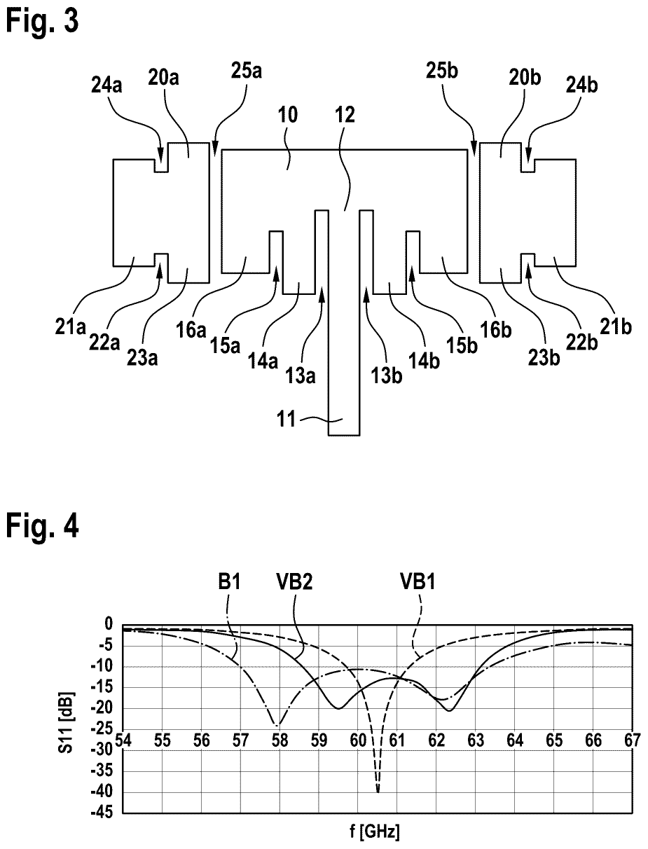

The patch antenna according to FIG. 2 differs from the patch antenna 10 according to FIG. 1 in that it has two further notches 15a, 15b, which run parallel to the first two notches 13a, 13b. This means that a pair of resonators 14a, 16a or 14b, 16b is formed on each side of the feed line 11. The outer resonators 16a, 16b have a shorter length than the inner resonators 14a, 14b, which increases the bandwidth compared to the patch antenna 10 according to FIG. 1. FIG. 3 shows an antenna arrangement according to an exemplary embodiment of the invention. This has a patch antenna 10, as represented in FIG. 2. A parasitic patch 20a, 20b is arranged beyond each of its two outer resonators 16a, 16b. This has a first resonator 21a, 21b, which is separated from a second resonator 23a, 23b by a notch 22a, 22b. The two resonators 21a-b, 23a-b have different lengths. A further notch 24a-b is arranged opposite the first notch 22a-b, which points in the same direction as the notches 13a-b, 15a-b of the patch antenna, such that the two parasitic patches 20a-b are each mirror-symmetrical. Their second resonator 23a-b is separated from the outer resonator 16a-b of the patch antenna 10 by an air gap 25a-b. The air gap 25a-b has a width of 100 μm.

FIG. 4 represents the input reflection coefficient S11 in a range of frequency f of 54 to 67 GHz for a first comparative example VB1 using the patch antenna according to FIG. 1, a second comparative example VB2 using the patch antenna according to FIG. 2 and an example B1 according to the invention using the antenna arrangement according to FIG. 3 respectively. The input reflection coefficient represents a measure of the broadband capacity of the antenna arrangement. The bandwidth is defined as the range in which S11 is less than −10 dB. The frequency ranges of lower reflection are the frequency ranges in which the antenna arrangement actively radiates. It can be seen from FIG. 4 that the bandwidth of the patch antenna can be significantly increased by providing the parasitic patches in the antenna arrangement according to the invention.

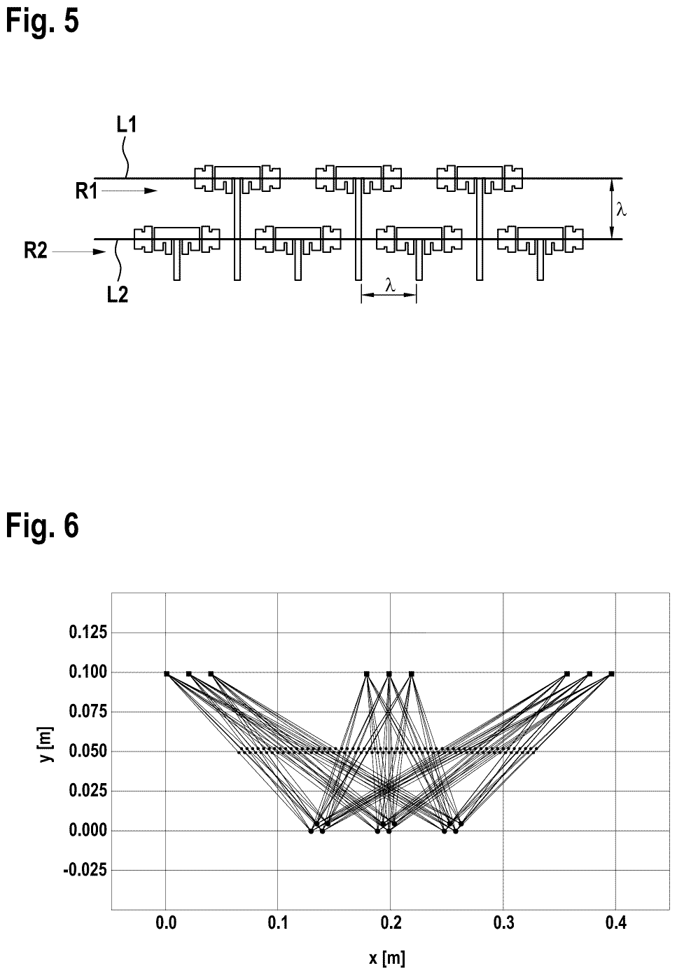

In a radar array according to a first exemplary embodiment of the invention, two parallel rows R1, R2 of antenna arrangements arranged offset to one another are provided according to FIG. 3. All patch antennas 10 and parasitic patches 20a, 20b lie together on the longitudinal axis L1, L2 of their respective rows R1, R2. The distance between the two rows R1, R2 is λ, wherein λ is the average wavelength of the radar waves emitted by the radar array. The distance between two antenna arrangements within each row is 2λ, wherein the two rows are offset from each other by the length λ. All feed lines 11 are continued in the radar array in the same direction, such that the feed lines of the first row R1 cross the second row R2, while the feed lines of the second row R2 are continued from the edge of the antenna arrangement array. This arrangement of antenna arrangements, which is represented in FIG. 5, can function as receiving antennas within the radar array. A further arrangement of antenna arrangements, not depicted, can function as transmitting antennas within the radar array.

This radar array functions as a MIMO system. FIG. 6 represents the position of multiple antenna arrangements in an x-y coordinate system of the radar array. The transmitting antennas are arranged in a single line at the top, and the receiving antennas are arranged in two lines at the bottom, according to FIG. 5. Between the transmitting antennas and the receiving antennas, a plurality of virtual antenna pairs are formed, the y-coordinate of which lies around a value of 0.050 m. These result from the central points of all connecting lines between each transmitting antenna and each receiving antenna. The virtual antenna pairs are replacement positions that outwardly act like a transmitting/receiving construct, as if a bidirectional antenna were present.

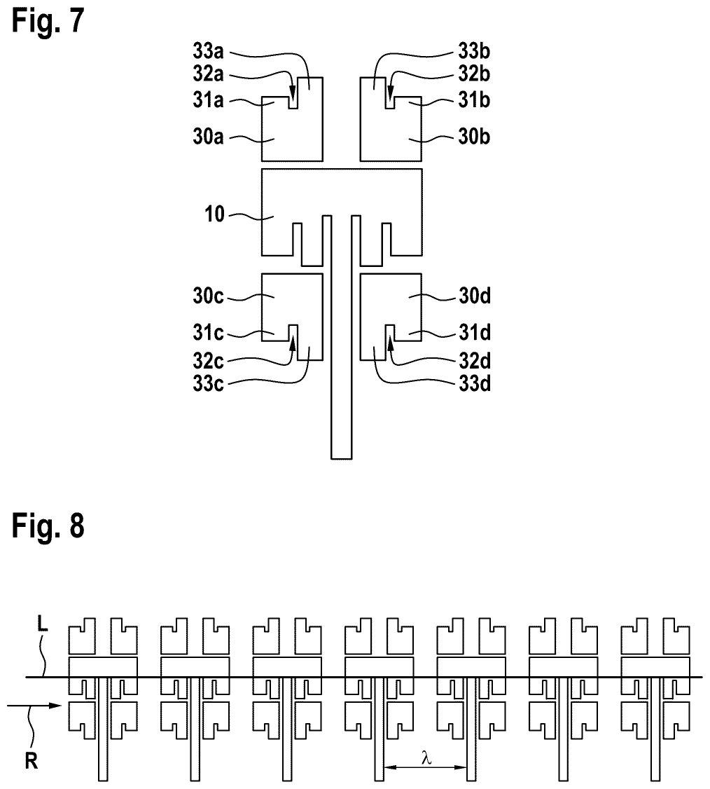

In a second exemplary embodiment of the antenna arrangement according to the invention, a patch antenna 10 according to FIG. 2 is used again. The antenna arrangement has four parasitic patches 30a-d. This is represented in FIG. 7. Each parasitic patch 30a-d has a first resonator 31a-d, which is separated from a second resonator 33a-d by a notch 32a-d. The resonators 31a-d, 33a-d have different lengths. Since these parasitic patches 30a-d each have only one notch 32a-d, they are not mirror-symmetrical, unlike the parasitic patches 20a-d of the first exemplary embodiment. While it is provided in the first exemplary embodiment that the parasitic patches 20a-b are each adjacent to the outer resonators 16a-b of the patch antenna 10, a different arrangement is provided in the second exemplary embodiment. Two resonators 30a-b are arranged on the side of the patch antenna 10 facing away from the feed line 11, and the other two parasitic patches 30c-d are arranged on the opposite side of the patch antenna to the left and right of the feed line 11. The parasitic patches 30a and 30b, as well as 30c and 30d, each form a mirror-symmetrical pair, as do the parasitic patches 30a and 30c as well as 30b and 30d.

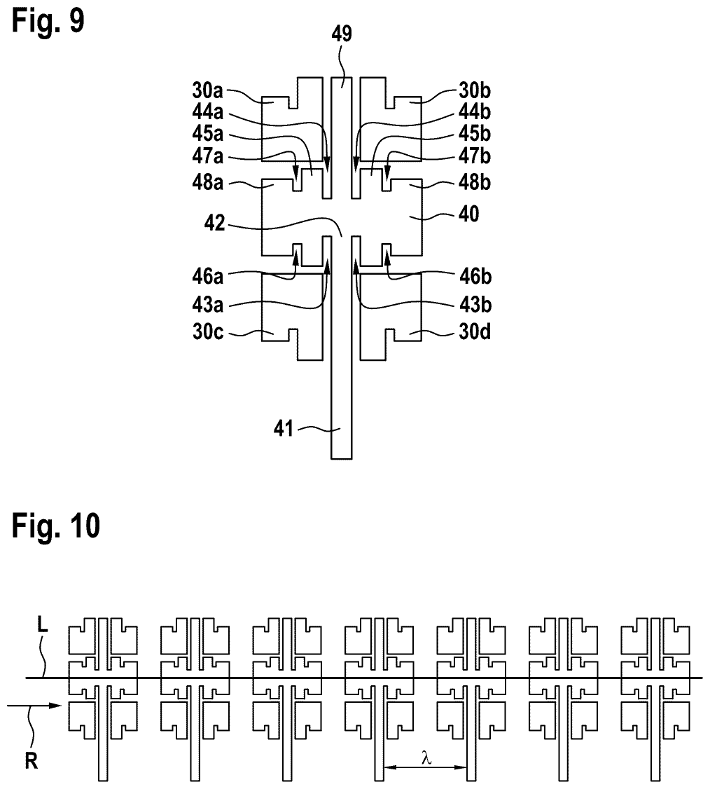

In a second exemplary embodiment of the radar array, represented in FIG. 8, multiple antenna arrangements are arranged along the longitudinal axis L of a row R in accordance with the second exemplary embodiment. The row R can be conceptually divided into multiple sub-rows. The inner sub-row has all patch antennas 10. An outer sub-row has all the parasitic patches 30a-b facing away from the feed lines 11 and a further outer sub-row has all the parasitic patches 30c-d facing the feed lines 11. The distance between two antenna arrangements within the row is 2. In a third exemplary embodiment of the antenna arrangement according to the invention, the same arrangement of parasitic patches 30a-d is provided as in the second exemplary embodiment. However, instead of the patch antenna 10 according to FIG. 2, a different design of a patch antenna 40 is used, which is represented in FIG. 9. Its feed line 41 ends at a feed point 42. Two notches 43a-b, 44a-b located opposite each other on both sides of the feed line 41 separate it from two internal resonators 45a-b. A further pair of notches 46a-b, 47a-b located opposite each other separates the inner resonators 45a-b from the outer resonators 48a-b. The inner resonators 45a-b and the outer resonators 48a-b are of different lengths. Unlike the patch antenna 10 according to FIG. 2, the patch antenna 40 not only has an axial symmetry to the feed line 41, but also a further axial symmetry to an axis that runs horizontally in FIG. 9. This symmetry is reinforced by the fact that an extension 49 is provided on the patch antenna 40, which elongates the feed line 41 on the opposite edge of the patch antenna 40 to the outermost edge of the parasitic patches 30a-b facing away from the feed line 41.

FIG. 10 shows the positioning of multiple antenna arrangements according to FIG. 9 in a third exemplary embodiment of the radar array according to the invention. In a similar manner as in the second exemplary embodiment of the radar array, all antenna arrangements are arranged along a single row R, the longitudinal axis L of which runs through the patch antennas 40. The parasitic patches 30a-30b facing away from the feed lines 41 form an outer sub-row, and the parasitic patches 30c-d, which flank the feed line 41, form a further outer sub-row, such that this row R can also be conceptually divided into three sub-rows. The distance between two antenna arrangements within the row is 2.

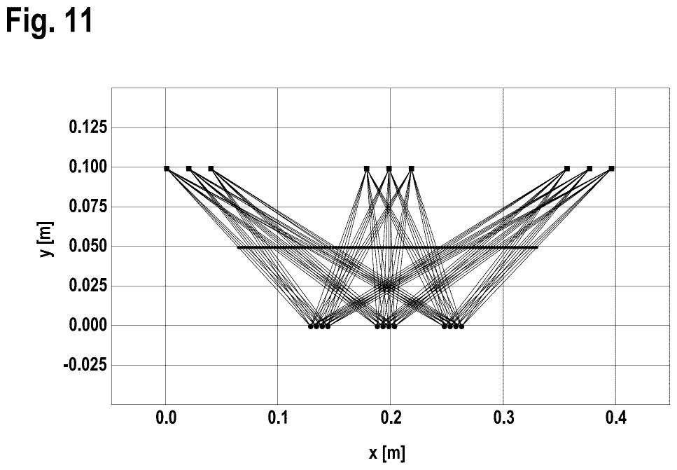

In the same way as in FIG. 6 for the first exemplary embodiment of the radar array, FIG. 11 represents the MIMO behaviour of the radar array in an x-y coordinate system for the second and third exemplary embodiments respectively. The top row of the antenna arrangements represented acts as a transmitter, and the bottom row acts as a receiver. The bottom row in the second exemplary embodiment of the radar array corresponds to the depiction in FIG. 8 and in the third exemplary embodiment of the radar array to the depiction in FIG. 10. In these exemplary embodiments too, a plurality of virtual antenna pairs are formed at a y-coordinate of 0.050 m, but unlike in the first exemplary embodiment of the radar array, these lie on a common y-coordinate.

The radar arrays according to all exemplary embodiments can be used for imaging processes in order to separate objects lying one behind the other from one another.

1. Antenna arrangement having a patch antenna with multiple notches and at least one pair of parasitic patches which are arranged in mirror symmetry at opposite ends of the patch antenna.

2. Antenna arrangement according to claim 1, characterised in that the notches of the patch antenna are arranged in axial symmetry to a feed line of the patch antenna.

3. Antenna arrangement according to claim 2, characterised in that the patch antenna has first notches which adjoin the feed line, and second notches which are arranged parallel to the first notches.

4. Antenna arrangement according to claim 3, characterised in that an amount of the electrical impedance at a feed point of the patch antenna is in the range from 40 Ω to 60 Ω.

5. Antenna arrangement according to claim 1, characterised in that the parasitic patches each have at least one notch.

6. Antenna arrangement according to claim 5, characterised in that the notches of the parasitic patches are each arranged on sides which do not adjoin the patch antenna.

7. Antenna arrangement according to claim 1, characterised in that a width of an air gap between the patch antenna and a parasitic patch is less than 10% of a length of the side of the patch antenna facing the parasitic patch in each case.

8. Radar array which is set up to transmit and receive radar waves with an average wavelength 2, having multiple antenna arrangements according claim 1.

9. Radar array according to claim 8, characterised in that the antenna arrangements are arranged in a row as receiving antennas or are arranged in a row as transmitting antennas, wherein the distance between two antenna arrangements within the row is λ.

10. Radar array according to claim 9, characterised in that a row of patch antennas is arranged between two rows of parasitic patches.

11. Radar array according to claim 10, characterised in that all notches of the patch antennas are arranged on the same side of the row of patch antennas.

12. Radar array according to claim 10, characterised in that the patch antennas have notches on both sides of the row of patch antennas, wherein the patch antennas each have an extension which is designed as an elongation of the feed line.

13. Radar array according to claim 8, characterised in that the antenna arrangements are arranged in two rows as receiving antennas or are arranged in two rows as transmitting antennas, wherein a distance between the rows is λ and a distance between two antenna arrangements within a row is 2λ.

14. Radar array according to claim 13, characterised in that, in each row, the patch antennas and the parasitic patches lie on the longitudinal axis of the row.

15. Radar array according to claim 13, characterised in that all notches of the patch antennas are arranged on the same side of the radar array, and the parasitic patches each have at least one notch on two opposite sides, wherein these notches run orthogonally to the longitudinal axis of the row.
